(19) United States
(12) Patent Application Publication
(10) Pub. No.: US 2023/0385628 A1
(43) Pub. Date: Nov. 30, 2023

(54) SYSTEMS AND METHODS FOR AUTOMATICALLY CONFIGURING DIFFERENT TYPES OF INTERNET OF THINGS DEVICES

(71) Applicant: Verizon Patent and Licensing Inc., Basking Ridge, NJ (US)

(72) Inventor: Kushal SINGLA, Bangalore (IN)

(73) Assignee: Verizon Patent and Licensing Inc., Basking Ridge, NJ (US)

(21) Appl. No.: 17/664,738

(22) Filed: May 24, 2022

(51) Int. Cl. G06N 3/08; G06K 9/62

(52) U.S. Cl. CPC G06N 3/08; G06K 9/6256; G16Y 30/00

(57) ABSTRACT

A device may receive device data identifying activation and usage of different types of IoT devices, and may identify a device activation sequence based on the device data. The device may train a model with the device activation sequence, and may generate output data based on training the model with the device activation sequence. The device may calculate weights and a loss function for the output data, and may retrain the model based on the weights and the loss function to generate a retrained model. The device may generate device representations of the different types of IoT devices using the retrained model, and may determine groups of similar IoT devices based on the device representations. The device may generate configuration data for each of the groups of the similar IoT devices, and may cause the different types of IoT devices to be configured based on the configuration data.

### BACKGROUND

The Internet of things (IoT) describes a network of physical objects (e.g., devices, things, and/or the like) that are embedded with sensors, software, and other technologies for the purpose of connecting and exchanging data with other devices and systems over a network, such as the Internet.

### BRIEF DESCRIPTION OF THE DRAWINGS

FIGS. 1A-1F are diagrams of an example associated with automatically configuring different types of IoT devices.

FIG. 2 is a diagram of an example environment in which systems and/or methods described herein may be implemented.

FIG. 3 is a diagram of example components of one or more devices of FIG. 2.

FIG. 4 is a flowchart of an example process for automatically configuring different types of IoT devices.

### DETAILED DESCRIPTION OF EXAMPLE EMBODIMENTS

The following detailed description of example implementations refers to the accompanying drawings. The same reference numbers in different drawings may identify the same or similar elements.

IoT devices (e.g., mobile phones, wearable communication devices, meters, sensors, connected vehicles, trackers, alarm panels, and/or the like) are associated with various attributes, such as activation times, deactivation times, usage periods, usage controls, device names, and/or the like. However, IoT devices may include different types of devices (e.g., a thermostat versus a motion detector) and a same type of IoT device may be manufactured by different manufacturers (e.g., a smart light sensor manufactured by Company X versus a smart light sensor manufactured by Company Y). Device information received from the different types of IoT devices and/or from the different manufactured IoT devices may be inconsistent, which makes configuring the IoT devices difficult. Thus, current systems for configuring IoT devices consume computing resources (e.g., processing resources, memory resources, communication resources, and/or the like), networking resources, and/or other resources associated with incorrectly configuring IoT devices based on inconsistent device information, failing to receive data from the IoT devices based on incorrectly configuring the IoT devices, accounting for lost data caused by incorrectly configuring the IoT devices, individually configuring each of the IoT devices, and/or the like.

Some implementations described herein provide a configuration system that automatically configures different types of IoT devices. For example, the configuration system may receive device data identifying activation and usage of different types of IoT devices, and may identify a device activation sequence based on the device data. The configuration system may train a model with the device activation sequence, and may generate output data based on training the model with the device activation sequence. The configuration system may calculate weights and a loss function for the output data, and may retrain the model based on the weights and the loss function to generate a retrained model. The configuration system may generate device representations of the different types of IoT devices using the retrained model, and may determine groups of similar IoT devices based on the device representations of the different types of IoT devices. The configuration system may generate configuration data for each of the groups of the similar IoT devices, and may cause the different types of IoT devices to be configured based on the configuration data.

In this way, the configuration system automatically configures different types of IoT devices. For example, the configuration system may receive activity and usage data associated with IoT devices, and may identify similar IoT devices based on the activity and usage data. The configuration system may create groups of similar IoT devices, and may similarly configure the IoT devices in each of the groups of similar IoT devices. Thus, the configuration system may conserve computing resources, networking resources, and/or other resources that would have otherwise been consumed by incorrectly configuring IoT devices based on inconsistent device information, failing to receive data from the IoT devices based on incorrectly configuring the IoT devices, accounting for lost data caused by incorrectly configuring the IoT devices, individually configuring each of the IoT devices, and/or the like.

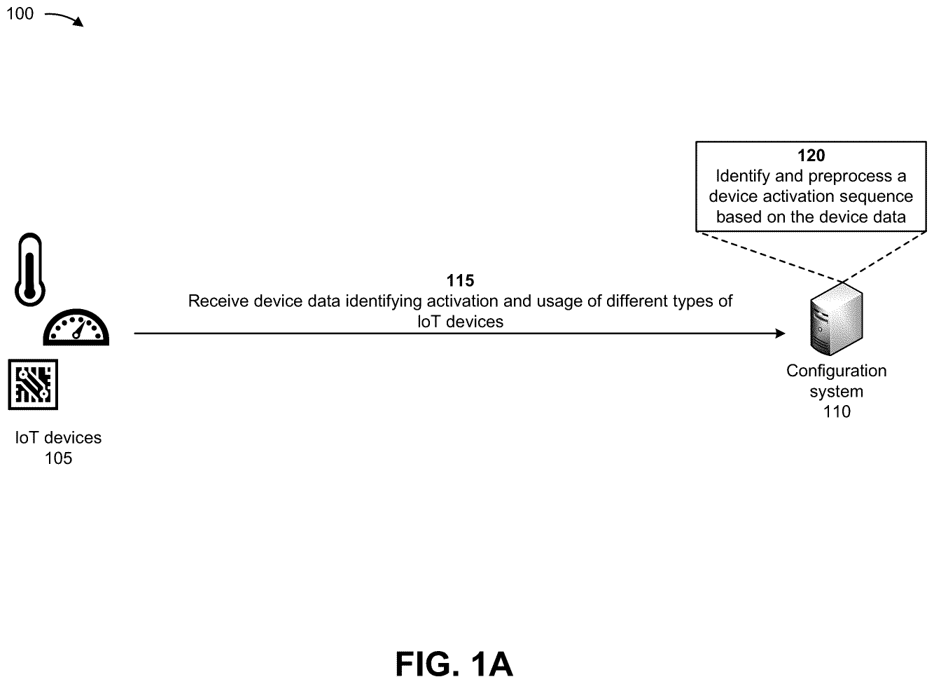

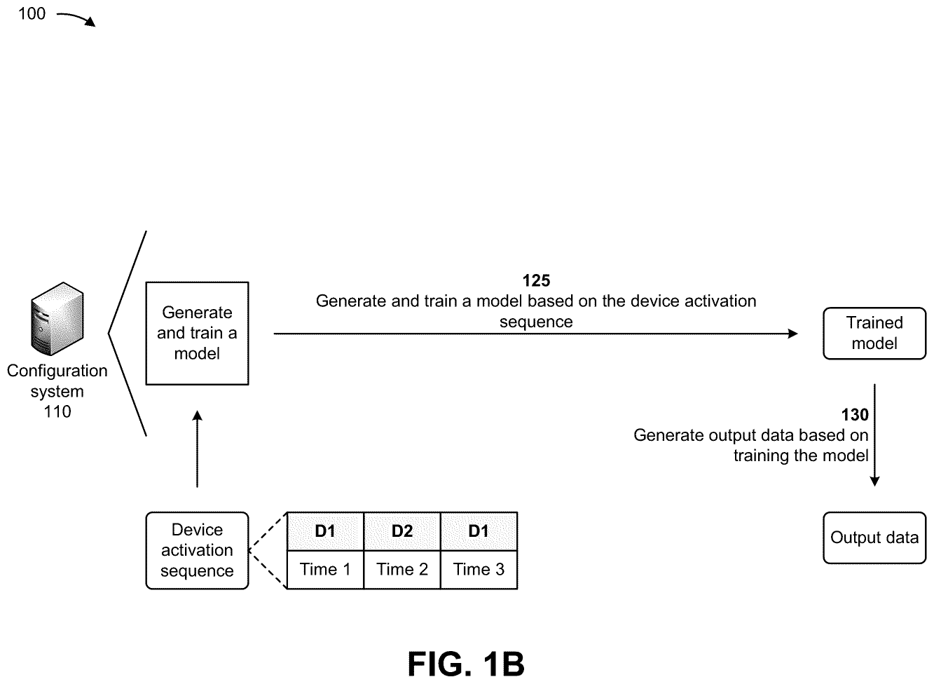

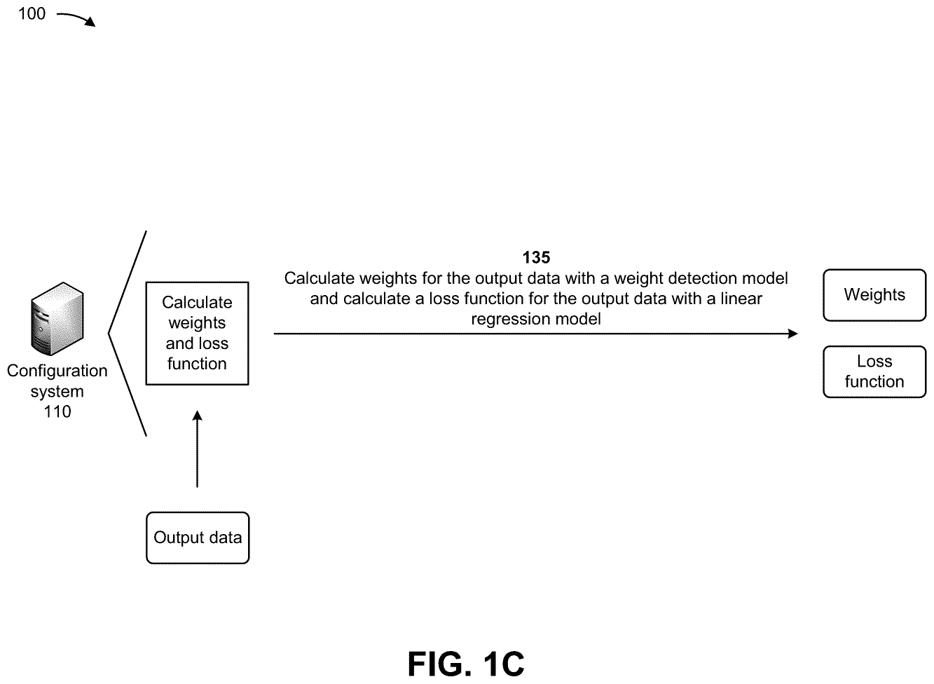

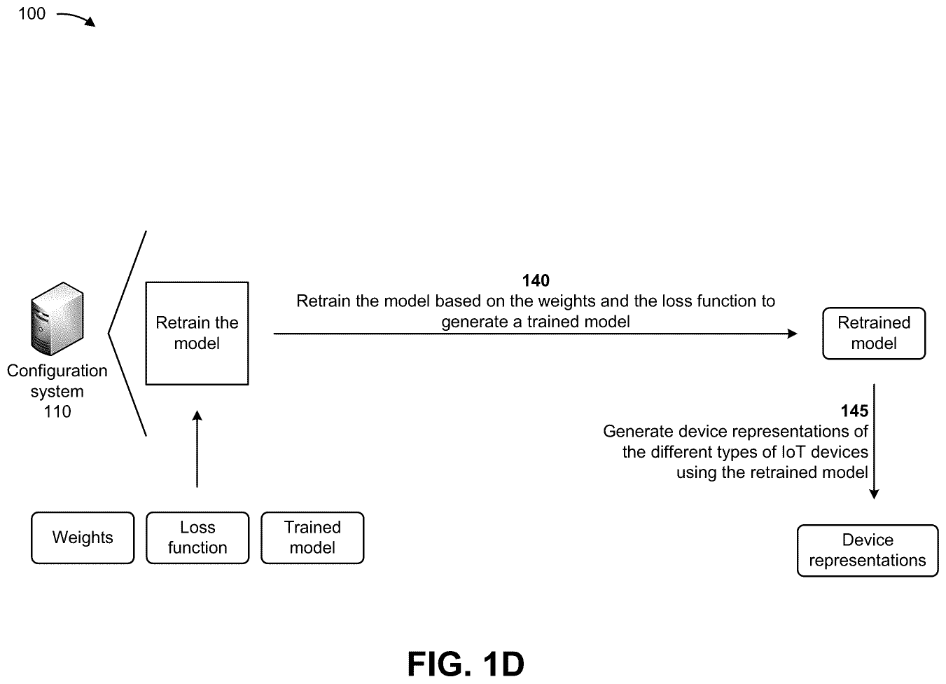

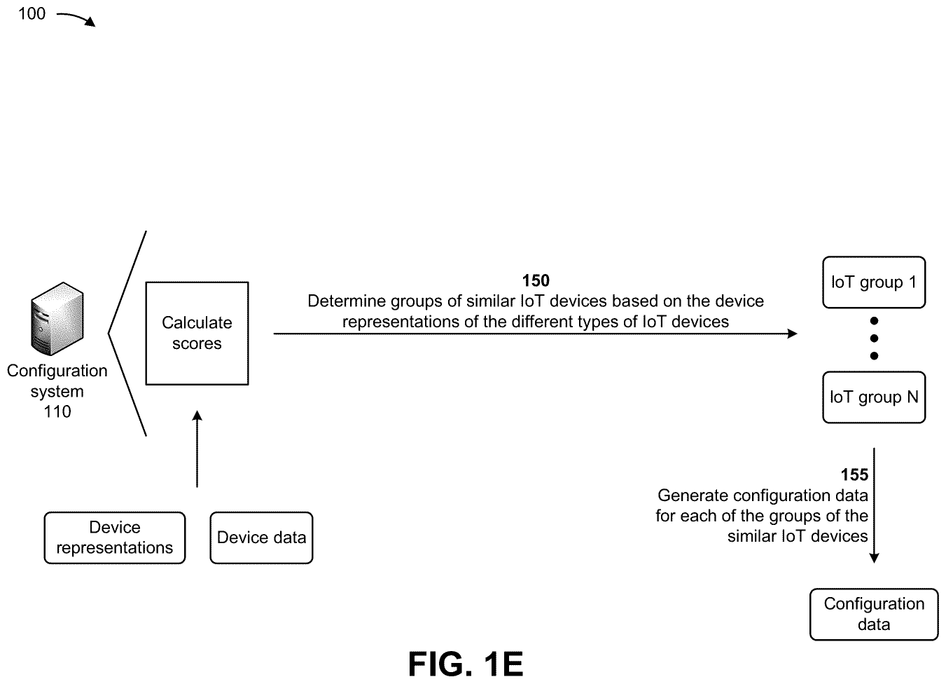

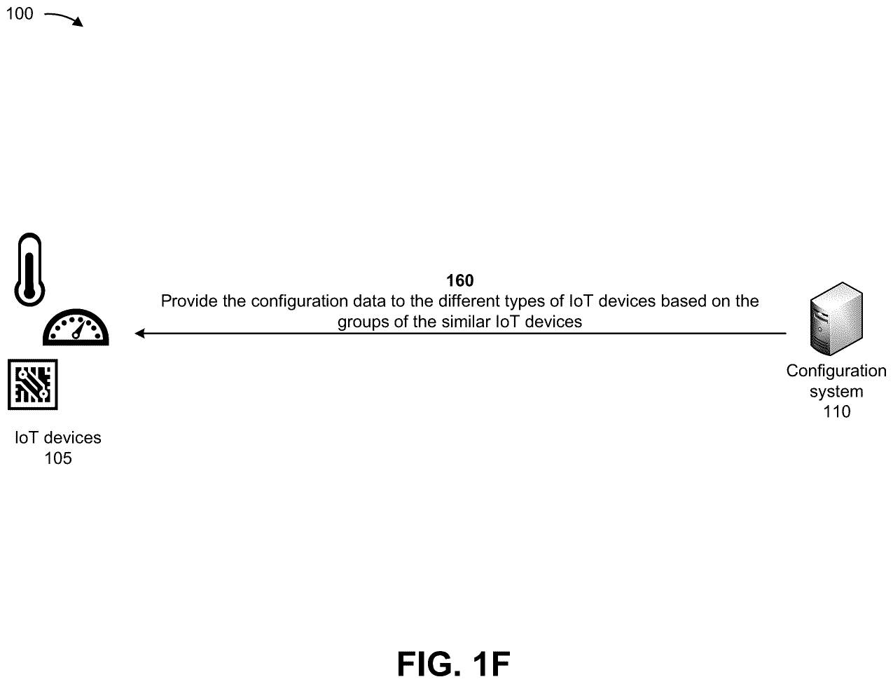

FIGS. 1A-1F are diagrams of an example 100 associated with automatically configuring different types of IoT devices. As shown in FIGS. 1A-1F, example 100 includes a plurality of IoT devices 105 associated with a configuration system 110. Further details of the IoT devices 105 and the configuration system 110 are provided elsewhere herein.

As shown in FIG. 1A, and by reference number 115, the configuration system 110 may receive device data identifying activation and usage of different types of IoT devices 105. For example, the IoT devices 105 may continuously generate the device data, periodically generate the device data, generate the device data based upon request, and/or the like. Thus, the configuration system 110 may continuously receive the device data from the IoT devices 105, periodically receive the device data from the IoT devices 105, receive the device data from the IoT devices 105 based upon providing requests for the device data to the IoT devices 105, and/or the like. The device data may include data identifying activation time periods of the IoT devices 105 (e.g., time periods during which the IoT devices 105 are powered on and activated); deactivation times of the IoT devices 105 (e.g., time periods when the IoT devices 105 are powered off and deactivated); usage time periods associated with the IoT devices 105; usage controls of the IoT devices 105 (e.g., detection precisions, detection sensitivities, and/or the like of the IoT devices 105); names of the IoT devices 105; identifiers of the IoT devices 105 (e.g., serial numbers, manufacturers, network addresses, and/or the like of the IoT devices 105); and/or the like.

As further shown in FIG. 1A, and by reference number 120, the configuration system 110 may identify and preprocess a device activation sequence based on the device data. For example, the configuration system 110 may review the device data to identify the activation times and the deactivation times associated with the IoT devices 105. The configuration system 110 may identify the device activation sequence for the IoT devices 105 based on the activation times and the deactivation times associated with the IoT devices 105. For example, the configuration system 110 may identify a device activation sequence indicating that a first IoT device 105 is activated for a first time period (e.g., Time 1), a second IoT device 105 is activated for a second time period (e.g., Time 2) occurring after the first time period, the first IoT device 105 is activated again for a third time period (e.g., Time 3) occurring after the second time period, and/or the like. In another example, the configuration system 110 may identify a device activation sequence indicating that ground floor IoT devices 105 are used only at night, second floor IoT devices 105 are used all the time, detection sensitivities are different for the IoT devices 105, and/or the like. The configuration system 110 may preprocess the device activation sequence by formatting the device activation sequence into a format to be processed by a model. For example, the configuration system 110 may preprocess the device activation sequence into a format to be processed by a neural network model.

As shown in FIG. 1B, and by reference number 125, the configuration system 110 may generate and train a model based on the device activation sequence. For example, the configuration system 110 may generate the model (e.g., a neural network model) by generating an input layer of size one (1) for the neural network model, and generating an output layer of a particular size (e.g., a size M that is based on a window size associated with the time periods) for the neural network model. The configuration system 110 may generate hidden internal layers for the neural network model, and may generate the neural network model based on the input layer, the output layer, and the hidden internal layers. The input layer may accept data and may pass the data to the hidden internal layers. The hidden internal layers may be responsible for performance and complexity of the neural network model, and may perform multiple functions at the same time, such as data transformation, automatic feature creation, and/or the like. The output layer may generate a result of processing the data with the hidden internal layers.

The configuration system 110 may train the model with the device activation sequence (or multiple device activation sequences) to generate a trained model. As described elsewhere herein, the model may be trained to generate device representations of the different types of IoT devices 105. In some implementations, rather than training the model, the configuration system 110 may obtain the trained machine learning model from another system or device that trained the model. In this case, the configuration system 110 may provide the other system or device with the device activation sequence for use in training the model, and may provide the other system or device with updated device activation sequences to retrain the model in order to update the model.

As further shown in FIG. 1B, and by reference number 130, the configuration system 110 may generate output data based on training the model. For example, when training the model, the configuration system 110 may process the device activation sequence, with the model, to generate the output data. In some implementations, the output data may correspond to the output layer of the neural network model. In some implementations, the output data may include encoded device data identifying the IoT devices 105 (e.g., model numbers, names, and/or the like), activation time periods for the IoT devices 105 (e.g., Time 1, Time 2, and/or the like),

As shown in FIG. 1C, and by reference number 135, the configuration system 110 may calculate weights for the output data with a weight detection model and may calculate a loss function for the output data with a linear regression model. For example, when calculating the weights for the output data, the configuration system 110 may utilize the weight detection model to create tuples (e.g., activation time tuples) based on the output data and to flip the tuples to generate flipped tuples. The configuration system 110 may process the flipped tuples, with a linear fit model, to predict unnormalized weights for the output data, and may normalize the unnormalized weights to calculate the weights for the output data.

The configuration system may calculate a linear equation (e.g., the loss function) for the output data with the linear regression model. For example, when calculating the loss function for the output data, the configuration system 110 may utilize the linear regression model to calculate the loss function based on the weights for the output data, quantities of time steps (e.g., activation time periods) for the IoT devices 105, and the activation time periods for the IoT devices 105. In some implementations, the loss function may provide a measure of how the neural network model fits the output data. For example, if the neural network model fails to fit the output data, the loss function may output a higher number. If the neural network model fits the output data, the loss function may output a lower number.

As shown in FIG. 1D, and by reference number 140, the configuration system 110 may retrain the model based on the weights and the loss function to generate a retrained model. For example, the configuration system 110 may modify the weights when the loss function outputs a lower number, and may retrain the neural network model based on the modified weights. The configuration system 110 may recalculate the loss function for the neural network model, after retraining the neural network model based on the modified weights, and may modify the modified weights until the loss function outputs a number that satisfies a threshold value (e.g., a higher number indicating that the neural network model fits the output data). In some implementations, when the loss function outputs a number that satisfies the threshold value, the configuration system 110 may store the retrained neural network model.

As further shown in FIG. 1D, and by reference number 145, the configuration system 110 may generate device representations of the different types of IoT devices 105 using the retrained model. For example, the configuration system 110 may process the device data, with the retrained model, to generate the device representations of the different types of IoT devices 105. The device representations may include representations of the different types of IoT devices 105, such as a representation of a motion detector sensor, a representation of a smoke detector, a representation of a thermostat, a representation of a machine sensor, a representation of a video camera, a representation of a temperature sensor, a representation of an electrical switch (e.g., for switching lights on or off), and/or the like. In this way, the configuration system 110 may generate a device representation for each of the different types of IoT devices 105, regardless of whether different manufacturers manufactured a same type of IoT device 105.

As shown in FIG. 1E, and by reference number 150, the configuration system 110 may determine groups of similar IoT devices 105 based on the device representations of the different types of IoT devices 105. For example, the configuration system 110 may identify a first device representation for a first type of IoT device 105 and may match the first device representation with IoT devices 105 of the first type. The configuration system 110 may group the IoT devices 105 of the first type into a first group (e.g., IoT group 1) of similar IoT devices 105. The configuration system 110 may identify a second device representation for a second type of IoT device 105 and may match the second device representation with IoT devices 105 of the second type. The configuration system 110 may group the IoT devices 105 of the second type into a second group (e.g., IoT group 2) of similar IoT devices 105. This process may continue until the configuration system 110 has assigned a group (e.g., up to IoT group N) to each of the IoT devices 105.

In some implementations, the configuration system 110 may determine the groups of similar IoT devices 105 based on the device representations and based on physical locations of the similar IoT devices 105. For example, a first set of motion detectors may be located on a first floor of a building and a second set of motion detectors may be located on a second floor of the building. The first set of motion detectors may be utilized at night since people are present on the first floor during daytime hours, and the second set of motion detectors may be utilized all of the time since people are never present on the second floor. In such an example, the configuration system 110 may assign the first set of motion detectors to a first group of similar IoT devices 105, and may assigned the second set of motion detectors to a second group of similar IoT devices 105. In some implementations, the configuration system 110 may determine the groups of similar IoT devices 105 based on the device representations and other features of the IoT devices 105 (e.g., detection precision, detection sensitivities, and/or the like).

In some implementations, the configuration system 110 may identify IoT devices 105 that operate in a same context and/or perform a same function. For example, an activation of a first motion sensor may be followed by an activation of a first lighting device in a first room and an activation of a second motion sensor may be followed by an activation of a second lighting device in a second room. By observing this pattern, the configuration system 110 may determine that the first lighting device is similar to the second lighting device in function and is used in a similar context.

As further shown in FIG. 1E, and by reference number 155, the configuration system 110 may generate configuration data for each of the groups of the similar IoT devices 105. For example, the configuration system 110 may generate first configuration data for the first group of the similar IoT devices 105 (e.g., IoT group 1), may generate second configuration data for the second group of the similar IoT devices 105 (e.g., IoT group 2), may generate Nth configuration data for the Nth group of the similar IoT devices 105 (e.g., IoT group N), and/or the like. The first configuration data may include configuration data associated with the similar IoT devices 105 in the first group, the second configuration data may include configuration data associated with the similar IoT devices 105 in the second group, the Nth configuration data may include configuration data associated with the similar IoT devices 105 in the Nth group, and/or the like. The configuration data may include data identifying activation times, deactivation times, detection precisions, detection sensitivities, threshold settings, and/or the like associated with the groups of the similar IoT devices 105. For example, a smart home may include a group of lighting control devices, a group of temperature control devices, and a group of motion control devices. In such an example, the configuration system 110 may generate lighting control configuration data for the group of lighting control devices, temperature control configuration data for the group of temperature control devices, and motion control configuration data for the group of motion control devices.

As shown in FIG. 1F, and by reference number 160, the configuration system 110 may provide the configuration data to the different types of IoT devices 105 based on the groups of the similar IoT devices 105. For example, the configuration system 110 may provide the first configuration data to the first group of the similar IoT devices 105 (e.g., IoT group 1), may provide the second configuration data to the second group of the similar IoT devices 105 (e.g., IoT group 2), may provide the Nth configuration data to the Nth group of the similar IoT devices 105 (e.g., IoT group N), and/or the like. Each IoT device 105 of the first group of the similar IoT devices 105 may receive the first configuration data and may configure the IoT device 105 with the first configuration data, each IoT device 105 of the second group of the similar IoT devices 105 may receive the second configuration data and may configure the IoT device 105 with the second configuration data, each IoT device 105 of the Nth group of the similar IoT devices 105 may receive the Nth configuration data and may configure the IoT device 105 with the Nth configuration data, and/or the like.

In some implementations, the configuration system 110 may provide the retrained model to another device for implementation. The other device may utilize the retrained model to generate the device representations of the different types of IoT devices 105. The other device may determine the groups of similar IoT devices 105 based on the device representations of the different types of IoT devices 105, and may generate the configuration data for each of the groups of the similar IoT devices 105. The other device may cause the different types of IoT devices 105 to be configured based on the configuration data, as described above.

In some implementations, the configuration system 110 may analyze the device representations of the different types of IoT devices 105 to generate analysis results. The configuration system 110 may modify the retrained model based on the analysis results, and may utilize the modified model to generate new device representations of the different types of IoT devices 105.

In some implementations, the configuration system 110 may receive additional device data identifying activation and usage of other IoT devices 105, and may identify another device activation sequence based on the additional device data. The configuration system 110 may process the other device activation sequence, with the retrained model, to generate additional device representations of the other IoT devices 105, and may determine additional groups of similar IoT devices 105 based on the additional device representations. The configuration system 110 may generate additional configuration data for each of the additional groups, and may cause the other IoT devices 105 to be configured based on the additional configuration data.

In this way, the configuration system 110 automatically configures different types of IoT devices 105. For example, the configuration system 110 may receive activity and usage data associated with IoT devices 105, and may identify similar IoT devices 105 based on the activity and usage data. The configuration system 110 may create groups of similar IoT devices 105, and may similarly configure the IoT devices 105 in each of the groups of similar IoT devices 105. Thus, the configuration system 110 may conserve computing resources, networking resources, and/or other resources that would have otherwise been consumed by incorrectly configuring IoT devices 105 based on inconsistent device information, failing to receive data from the IoT devices 105 based on incorrectly configuring the IoT devices 105, accounting for lost data caused by incorrectly configuring the IoT devices 105, individually configuring each of the IoT devices, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

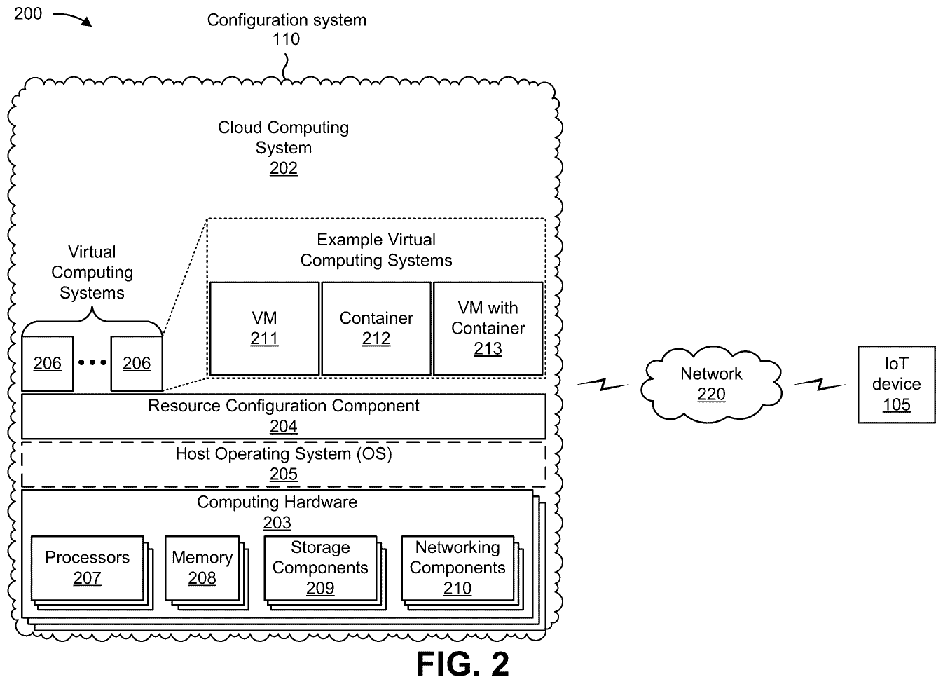

FIG. 2 is a diagram of an example environment 200 in which systems and/or methods described herein may be implemented. As shown in FIG. 2, the environment 200 may include the configuration system 110, which may include one or more elements of and/or may execute within a cloud computing system 202. The cloud computing system 202 may include one or more elements 203-213, as described in more detail below. As further shown in FIG. 2, the environment 200 may include the IoT device 105 and/or a network 220. Devices and/or elements of the environment 200 may interconnect via wired connections and/or wireless connections.

The IoT device 105 includes one or more devices capable of receiving, generating, storing, processing, and/or providing information, as described elsewhere herein. The IoT device 105 may include a communication device. For example, the IoT device 105 may include a wireless communication device, a mobile phone, a laptop computer, a tablet computer, a gaming console, a set-top box, a wearable communication device (e.g., a smart wristwatch, a pair of smart eyeglasses, a head mounted display, or a virtual reality headset), a video camera, a meter, a sensor, a connected vehicle, a tracker, an alarm panel, a manufacturing control system, or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

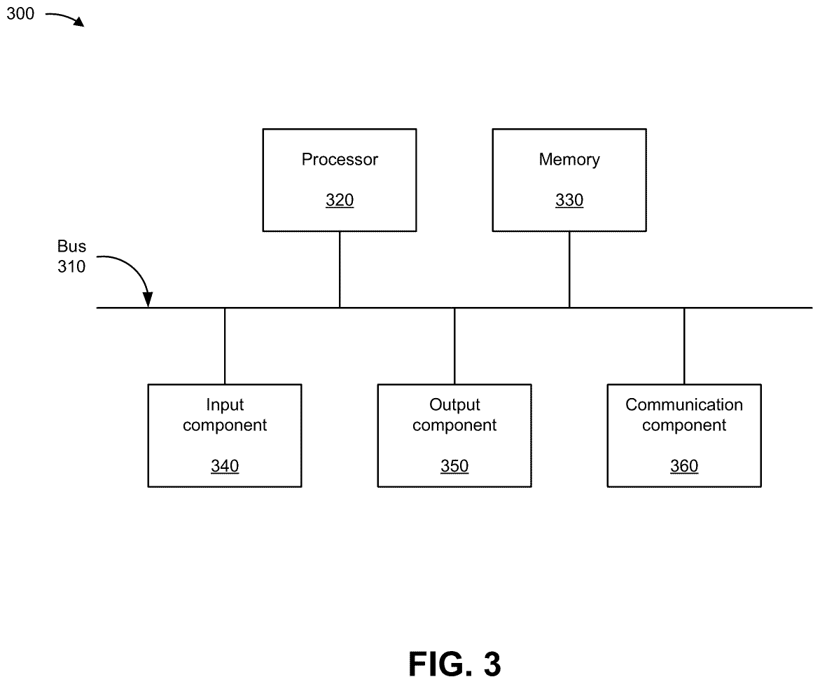

Although the configuration system 110 may include one or more elements 203-213 of the cloud computing system 202, may execute within the cloud computing system 202, and/or may be hosted within the cloud computing system 202, in some implementations, the configuration system 110 may not be cloud-based (e.g., may be implemented outside of a cloud computing system) or may be partially cloud-based. For example, the configuration system 110 may include one or more devices that are not part of the cloud computing system 202, such as the device 300 of FIG. 3, which may include a standalone server or another type of computing device. The configuration system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the IoT device 105 and/or the configuration system 110. In some implementations, the IoT device 105 and/or the configuration system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

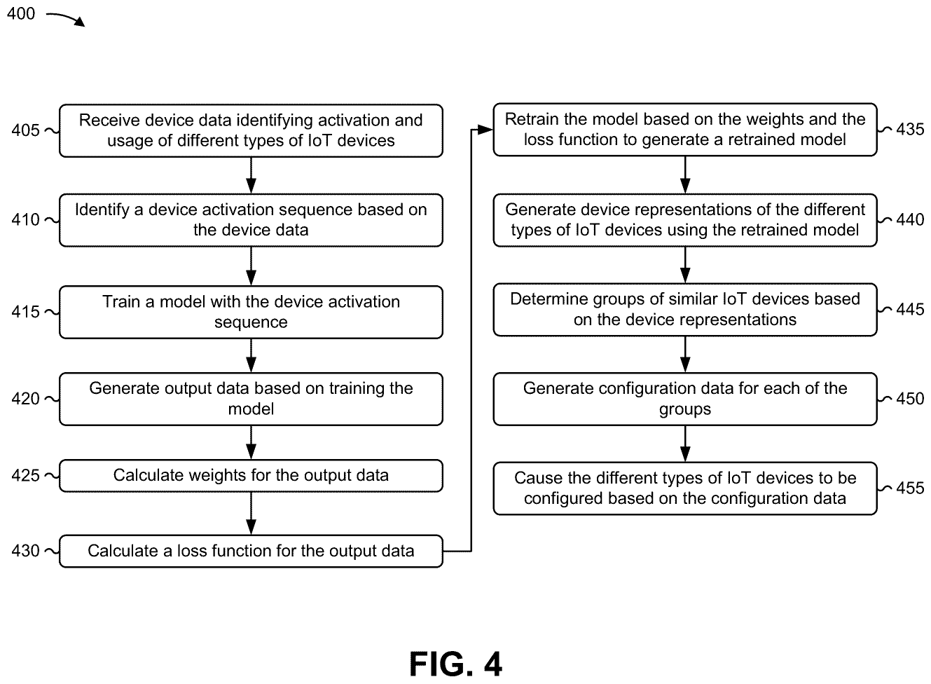

FIG. 4 is a flowchart of an example process 400 for automatically configuring different types of IoT devices. In some implementations, one or more process blocks of FIG. 4 may be performed by a device (e.g., the configuration system 110). In some implementations, one or more process blocks of FIG. 4 may be performed by another device or a group of devices separate from or including the device, such as an IoT device (e.g., the IoT device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving device data identifying activation and usage of different types of IoT devices (block 405). For example, the device may receive device data identifying activation and usage of different types of IoT devices, as described above.

As further shown in FIG. 4, process 400 may include identifying a device activation sequence based on the device data (block 410). For example, the device may identify a device activation sequence based on the device data, as described above.

As further shown in FIG. 4, process 400 may include training a model with the device activation sequence (block 415). For example, the device may train a model with the device activation sequence, as described above. In some implementations, the model is a neural network model. In some implementations, the model includes an input layer to receive the device activation sequence, a hidden layer to process the device activation sequence and generate the output data, and an output layer to store the output data.

As further shown in FIG. 4, process 400 may include generating output data based on training the model (block 420). For example, the device may generate output data based on training the model with the device activation sequence, as described above.

As further shown in FIG. 4, process 400 may include calculating weights for the output data (block 425). For example, the device may calculate weights for the output data with a weight detection model, as described above. In some implementations, calculating the weights for the output data with the weight detection model includes creating tuples based on the output data, flipping the tuples to generate flipped tuples, processing the flipped tuples, with a linear fit model, to predict unnormalized weights for the output data, and normalizing the unnormalized weights to calculate the weights for the output data.

As further shown in FIG. 4, process 400 may include calculating a loss function for the output data (block 430). For example, the device may calculate a loss function for the output data with a linear regression model, as described above. In some implementations, the loss function provides a measure of how the model fits the output data.

As further shown in FIG. 4, process 400 may include retraining the model based on the weights and the loss function to generate a retrained model (block 435). For example, the device may retrain the model based on the weights and the loss function to generate a retrained model, as described above.

As further shown in FIG. 4, process 400 may include generating device representations of the different types of IoT devices using the retrained model (block 440). For example, the device may generate device representations of the different types of IoT devices using the retrained model, as described above.

As further shown in FIG. 4, process 400 may include determining groups of similar IoT devices based on the device representations (block 445). For example, the device may determine groups of similar IoT devices based on the device representations of the different types of IoT devices, as described above.

As further shown in FIG. 4, process 400 may include generating configuration data for each of the groups (block 450). For example, the device may generate configuration data for each of the groups of the similar IoT devices, as described above.

As further shown in FIG. 4, process 400 may include causing the different types of IoT devices to be configured based on the configuration data (block 455). For example, the device may cause the different types of IoT devices to be configured based on the configuration data, as described above.

In some implementations, process 400 includes preprocessing the device activation sequence prior to training the model based on the device activation sequence. In some implementations, process 400 includes preparing the model with an input layer of one and an output layer based on a window size, prior to training the model, defining hidden internal layers of the model prior to training the model, and generating the model based on the input layer, the output layer, and the hidden internal layers. In some implementations, process 400 includes providing the retrained model to another device for implementation.

In some implementations, process 400 includes one of providing the retrained model to another device for implementation, or storing the retrained model. In some implementations, process 400 includes analyzing the device representations of the different types of IoT devices to generate analysis results, and modifying the retrained model based on the analysis results.

In some implementations, process 400 includes receiving additional device data identifying activation and usage of other IoT devices, identifying another device activation sequence based on the additional device data, and processing the other device activation sequence, with the retrained model, to generate additional device representations of the other IoT devices. In some implementations, process 400 includes determining additional groups of similar IoT devices based on the additional device representations, generating additional configuration data for each of the additional groups, and causing the other IoT devices to be configured based on the additional configuration data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, device data identifying activation and usage of different types of IoT devices;
identifying, by the device, a device activation sequence based on the device data;
training, by the device, a model with the device activation sequence;
generating, by the device, output data based on training the model with the device activation sequence;
calculating, by the device, weights for the output data with a weight detection model;
calculating, by the device, a loss function for the output data with a linear regression model;
retraining, by the device, the model based on the weights and the loss function to generate a retrained model;
generating, by the device, device representations of the different types of IoT devices using the retrained model;
determining, by the device, groups of similar IoT devices based on the device representations of the different types of IoT devices;
generating, by the device, configuration data for each of the groups of the similar IoT devices; and
causing, by the device, the different types of IoT devices to be configured based on the configuration data.

2. The method of claim 1, further comprising:
preprocessing the device activation sequence prior to training the model based on the device activation sequence.

3. The method of claim 1, wherein calculating the weights for the output data with the weight detection model comprises:
creating tuples based on the output data;
flipping the tuples to generate flipped tuples;
processing the flipped tuples, with a linear fit model, to predict unnormalized weights for the output data; and
normalizing the unnormalized weights to calculate the weights for the output data.

4. The method of claim 1, further comprising:
preparing the model with an input layer of one and an output layer based on a window size, prior to training the model;
defining hidden internal layers of the model prior to training the model; and
generating the model based on the input layer, the output layer, and the hidden internal layers.

5. The method of claim 1, wherein the model is a neural network model.

6. The method of claim 1, wherein the loss function provides a measure of how the model fits the output data.

7. The method of claim 1, further comprising:
providing the retrained model to another device for implementation.

8. A device, comprising:
one or more processors configured to:
receive device data identifying activation and usage of different types of IoT devices;
identify a device activation sequence based on the device data;
train a model with the device activation sequence;
generate output data based on training the model with the device activation sequence;
calculate weights for the output data with a weight detection model;
calculate a loss function for the output data with a linear regression model,
wherein the loss function provides a measure of how the model fits the output data;
retrain the model based on the weights and the loss function to generate a retrained model;
generate device representations of the different types of IoT devices using the retrained model;
determine groups of similar IoT devices based on the device representations of the different types of IoT devices;
generate configuration data for a group of the similar IoT devices; and
cause the group of similar IoT devices to be configured based on the configuration data.

9. The device of claim 8, wherein the one or more processors are further configured to:
preprocess the device activation sequence prior to training the model based on the device activation sequence.

10. The device of claim 8, wherein the one or more processors are further configured to one or more of:
provide the retrained model to another device for implementation; or
store the retrained model.

11. The device of claim 8, wherein the one or more processors are further configured to:
analyze the device representations of the different types of IoT devices to generate analysis results; and
modify the retrained model based on the analysis results.

12. The device of claim 8, wherein the one or more processors are further configured to:
receive additional device data identifying activation and usage of other IoT devices;
identify another device activation sequence based on the additional device data; and
process the other device activation sequence, with the retrained model, to generate additional device representations of the other IoT devices.

13. The device of claim 12, wherein the one or more processors are further configured to:
determine additional groups of similar IoT devices based on the additional device representations;
generate additional configuration data for each of the additional groups; and
cause the other IoT devices to be configured based on the additional configuration data.

14. The device of claim 8, wherein the model includes an input layer to receive the device activation sequence, a hidden layer to process the device activation sequence and generate the output data, and an output layer to store the output data.

15. A non-transitory computer-readable medium storing a set of instructions, the set of instructions comprising:
one or more instructions that, when executed by one or more processors of a device, cause the device to:
receive device data identifying activation and usage of different types of IoT devices;
identify a device activation sequence based on the device data;
train a model with the device activation sequence,
wherein the model is a neural network model;
generate output data based on training the model with the device activation sequence;
calculate weights for the output data with a weight detection model;
calculate a loss function for the output data with a linear regression model;
retrain the model based on the weights and the loss function to generate a retrained model;
generate device representations of the different types of IoT devices using the retrained model;
determine groups of similar IoT devices based on the device representations of the different types of IoT devices;
generate configuration data for a group of the similar IoT devices; and
cause the group of similar IoT devices to be configured based on the configuration data.

16. The non-transitory computer-readable medium of claim 15, wherein the one or more instructions, that cause the device to calculate the weights for the output data with the weight detection model, cause the device to:
create tuples based on the output data;
flip the tuples to generate flipped tuples;
process the flipped tuples, with a linear fit model, to predict unnormalized weights for the output data; and
normalize the unnormalized weights to calculate the weights for the output data.

17. The non-transitory computer-readable medium of claim 15, wherein the one or more instructions further cause the device to:
prepare the model with an input layer of one and an output layer based on a window size, prior to training the model;
define hidden internal layers of the model prior to training the model; and
generate the model based on the input layer, the output layer, and the hidden internal layers.

18. The non-transitory computer-readable medium of claim 15, wherein the one or more instructions further cause the device to:
provide the retrained model to another device for implementation.

19. The non-transitory computer-readable medium of claim 15, wherein the one or more instructions further cause the device to:
preprocess the device activation sequence prior to training the model based on the device activation sequence.

20. The non-transitory computer-readable medium of claim 15, wherein the one or more instructions further cause the device to:
analyze the device representations of the different types of IoT devices to generate analysis results; and
modify the retrained model based on the analysis results.
